(19) United States
(12) Patent Application Publication
(10) Pub. No.: US 2012/0279587 A1
(43) Pub. Date: Nov. 8, 2012

(54) COMPRESSOR SYSTEM WITH RAPID ACCESS VALVE

(76) Inventors: Donald W. Pemberton, Medina, TN (US); Robert W. Westphal, Jackson, TN (US)

(21) Appl. No.: 13/288,758

(22) Filed: Nov. 3, 2011

Related U.S. Application Data
(60) Provisional application No. 61/410,160, filed on Nov. 4, 2010.

(51) Int. Cl. F16K 15/00

(52) U.S. Cl. 137/528

(57) ABSTRACT

A check valve is provided for use with a compressor system having a pump and a storage tank, the check valve including a housing including an inlet connected to the pump, a tank port in fluid communication with the storage tank, and a bypass port, all in fluid communication with each other, and with a chamber. A reciprocating piston is disposed in the chamber and has a heavy spring at one end, and a light spring at the other end. The check valve is constructed and arranged so that pressurized air is accessible from the bypass port prior to the storage tank being fully pressurized.

### RELATED APPLICATION

This application claims priority under 35 USC 119(e) from Ser. No. 61/410,160 filed Nov. 4, 2010.

### BACKGROUND

The present invention relates to compressors, also referred to as compressor systems, having air storage tanks and configured for providing compressed air for inflating products and for powering pneumatic tools, among other things, and more specifically to a valve for a compressor system.

Compressors are well known for providing compressed air for powering pneumatic devices such as paint spray guns, power wrenches, and the like, or for inflating products such as vehicle tires, air mattresses, pool toys, etc. A typical compressor system includes a pump, a regulator, an air storage tank, a pressure gauge, various controls such as pressure switches and check valves, and related pneumatic lines for connecting the various components.

A common problem of conventional compressor systems is the time required for filling the storage tank prior to the compressed air being usable by the consumer. While systems exist that permit the user to access compressed air from the pump prior to the storage tank being filled, such systems operate at high pump pressures and temperatures. Thus, conventional systems cause excessive wear on the pump and other components.

### SUMMARY

The above-identified drawback is met by the present rapid access check valve, also referred to as a floating piston check valve, and related compressor system, which are designed to permit user access to compressed air prior to the storage tank being fully pressurized. The present rapid access check valve includes a housing enclosing a heavy return spring which biases a floating piston within the chamber towards a valve closed position. In addition, at an opposite end of the piston from the heavy spring, a light spring biases a poppet against the valve chamber inlet port. As the pump gradually pressurizes the tank, the tank pressure biases the piston against the heavy spring, instead of forcing the pump to overcome the spring pressure to open the valve. While the storage tank is being pressurized, the relatively lower biasing force of the light spring facilitates the ability of a quick connect fitting to deliver pressurized air prior to full storage tank pressurization. The light spring retains the poppet in position to close the inlet. Thus, once the storage tank is pressurized, the floating piston check valve is configured so that tank pressure is used to bias the floating piston in the valve housing, and accordingly the pressure load on the pump is reduced.

More specifically, a check valve is provided for use with a compressor system having a pump and a storage tank, the check valve including a housing including an inlet connected to the pump, a tank port in fluid communication with the storage tank, and a bypass port, all in fluid communication with each other, and with a chamber. A reciprocating piston is disposed in the chamber and has a heavy spring at one end, and a light spring at the other end. The check valve is constructed and arranged so that pressurized air is accessible from the bypass port prior to the storage tank being fully pressurized.

In another embodiment, a compressor system is provided and includes a pump, a storage tank in fluid communication with the pump, a first check valve in fluid communication with and disposed between the pump and the storage tank, a pressure switch in fluid communication with the storage tank and preset to shut off the pump when a preset tank pressure is reached. A second check valve is in fluid communication with and disposed between the pressure switch and a quick connect fitting, the quick connect fitting being in fluid communication with the pump, separately from the connection with the pressure switch. A third check valve is in fluid communication with, and disposed between the pump and said quick connect fitting; and one of the first, second and third check valves including a floating piston biased at one end by a heavy spring, and at an opposite end by a light spring.

### BRIEF DESCRIPTION OF THE DRAWINGS

FIG. 1 is a schematic view of the present compressor system;

FIG. 2 is a side perspective view of the present floating piston check valve;

FIG. 3 is a side perspective view of an alternate embodiment of the present floating piston check valve;

FIG. 4 is a partial vertical cross-section of the present floating piston check valve at 0-20 PSI tank pressure;

FIG. 5 is a partial vertical cross-section of the present floating piston check valve at 20-60 PSI tank pressure;

FIG. 6 is a partial vertical cross-section of the present floating piston check valve at 60-150 PSI tank pressure;

FIG. 7 is a chart comparing inflation times of various commercial compressor units; and

FIG. 8 is a schematic of another embodiment of the present compressor system.

### DETAILED DESCRIPTION

Referring to FIG. 1, the present compressor system is generally designated 10, and includes a pump 12, generally electrically or gas powered, as is known in the art, connected through a storage tank pneumatic line 14 to a storage tank 16. The size of the tank 16 may vary according to the application. As is known in the art, the tank 16 is equipped with a pressure overflow or relief valve 18. To prevent air from the storage tank 16 from returning through the line 14 to the pump 12, the line is equipped with the present floating piston check valve 20 in fluid communication with and disposed between the pump 12 and the tank 16, and described in greater detail below.

The storage tank line 14 is connected to a main pump line 22 that includes a segment 24 connecting the pump to a pressure switch 26 that is preset to shut off the pump 12 when the monitored pressure in the storage tank 16 reaches a designated level. It is contemplated that the segment 24, which is optional, may assume a variety of configurations as long as the pressure switch 26 adequately monitors the pressure in the tank 16. Also, while a particular configuration of pressure switch 26 is depicted, it should be understood that other equivalent pressure switches known in the art are suitable options, depending on the application. The pressure switch 26 is connected to the storage tank 16 through a line 28, which also connects the pressure switch to a tank pressure gauge 30. A second check valve 32 is located in the line 28 between the pressure switch 26, the pressure gauge 30 and a pressure regulator 34 to prevent backflow of pressurized air either to the storage tank 16 or to the pump 12.

As is known in the art, the pressure regulator 34 is user adjustable to regulate the pressure output from the storage tank 16. Further, the regulator 34 is equipped with a respective pressure gauge 36 for measuring the pressure in the line 28, to which is connected the compressor output 38, referred to here as a conventional accessory quick connect (QC) fitting. Suitable pneumatic accessories, such as inflators, air wrenches, paint spray guns, and the like are connectable to the fitting 38 for receiving pressurized air. It should be noted that the second check valve 32 is located between, and is in fluid communication with, the pressure switch 28 and the compressor outlet 38.

An third or inline check valve 40 is connected between the pump 12 via the main pump line 22, through the inlet port 44 of the first check valve 20, then through the bypass port 48. A bias line 42 connects the check valve 40 and the pump 12 with the quick connect fitting 38 for providing a user with the capability of obtaining compressed air directly from the pump before the storage tank 16 is fully pressurized. This feature reduces the time the user must wait before compressed air is available. As is the case with the second check valve 32, the inline check valve 40 prevents backflow of compressed air back to the pump 12. As will be seen from FIG. 1, the three check valves 20, 32 and 40 are preferably remotely located from each other in the system 10.

Referring now to FIG. 2, the floating piston check valve 20 is shown to have a housing 42 with an inlet 44 at one end and an endcap 46 at the opposite end. In some embodiments, the endcap 46 is threadably attached to the housing 42. Besides the inlet 44 which receives compressed air from the pump 12, the housing 42 typically has two other ports, a bypass port 48 connected to the main pump line 22 for supplying the quick connect fitting 38, and a tank port 50 connected to the line 14 and ultimately to the storage tank 16 for pressurizing the tank. As seen in FIG. 3, the arrangement of the ports 44, 48, 48′ and 50 may vary on the housing 42 to suit the situation, and additional ports, such as 48′ are contemplated.

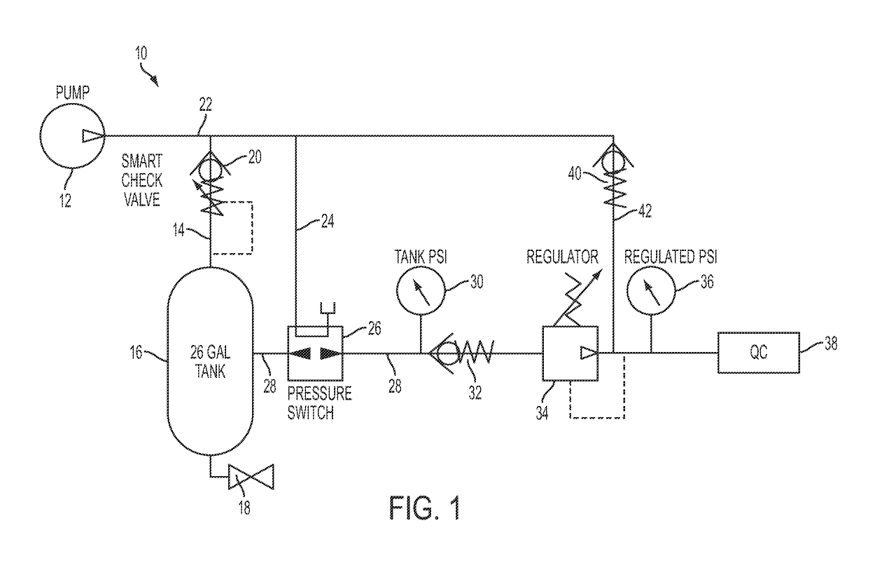

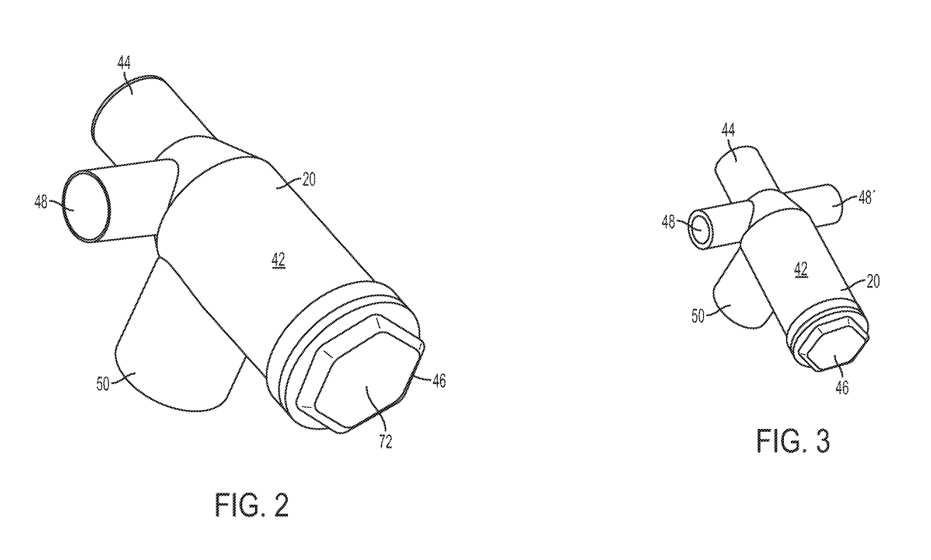

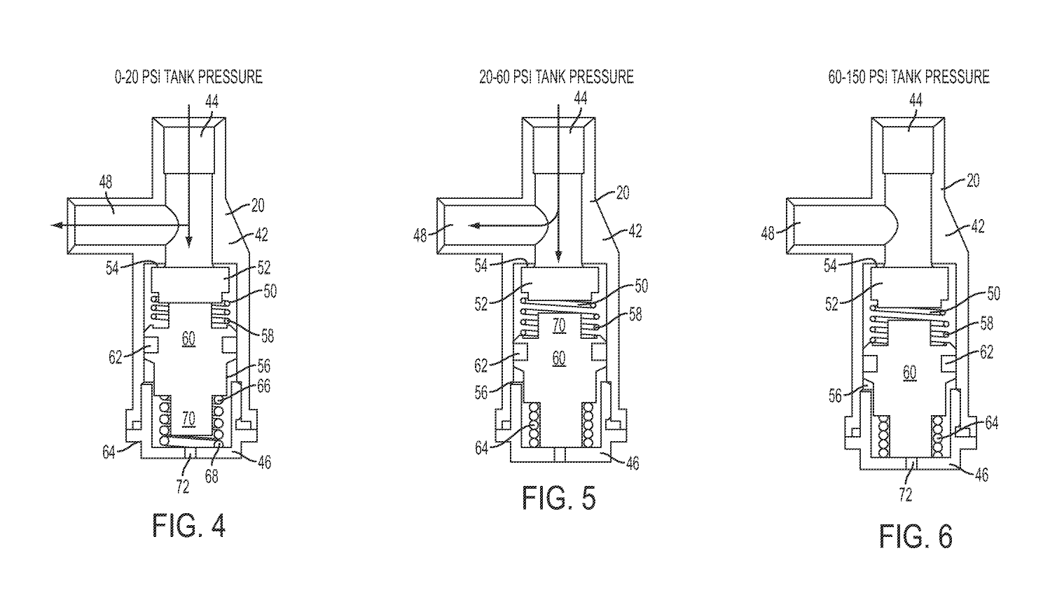

Referring now to FIGS. 4-6, the operation of the present floating check valve 20 will be described in greater detail. In FIG. 4, with the pressure in the storage tank 16 being 0 PSI, compressed air from the pump 12 enters the inlet 44 and eventually displaces a check valve poppet 52 configured for sealing an inlet port 54 in the housing 42. The valve poppet 52 is located within a generally cylindrical chamber 56 defined by the housing 42, and the inlet 54 is disposed at an upper end of the chamber. It should be noted that the size, volume and/or shape of the chamber 56 may vary to suit the application.

A light pressure coiled spring 58 located between the piston 60 and the valve poppet 52 biases the valve poppet against the inlet port 54, and is seated at an opposite end against a floating check valve piston 60. Being fitted with at least one sealing O-ring 62, the piston 60 reciprocates in the chamber 56. The O-ring 62 defines the chamber 56 into a pressurized portion on the upper or light spring side, and a non-pressurized portion on the opposite, lower or endcap side. At an end opposite from the light spring 58, a heavy spring 64 is seated on the piston 60 at a first end 66, and against the endcap 46 at a second, opposite end 68. Both the light and heavy springs 58, 64 are located upon the respective upper and lower ends of the piston 60 using locating lugs 70 as are known in the art. In the present application, a “light” spring is generally considered to be in the range of 1 to 10 pounds of force, and a “heavy” spring is generally considered to be in the range of 30 to 100 pounds of force. However, it will be appreciated that these ranges may vary to suit the application.

As pressure builds in the storage tank, from 0-20 PSI as seen in FIG. 4, the heavy spring 64 creates back pressure, preventing compressed air from entering the storage tank 16 until sufficient pressure is achieved by the pump 12. As tank pressure increases, the piston 60 moves backward towards the endcap 46. In FIGS. 4-6, it will be understood that the tank port 50 is located behind the piston 60 and in fluid communication with the chamber 56.

While the storage tank 16 is being pressurized, should the user desire compressed air for operating a tool or inflating a product, pressurized air from the pump 12 can be accessed through the diversion of the incoming air from the inlet 44 to the bypass port 48 which is in fluid communication with the compressor outlet, QC fitting 38. Up to about 90 PSI pressure is available through the bypass port 48 before air is forwarded to the storage tank 16. Thus, the user can use the pump 12 to satisfy relatively low PSI demand before the storage tank 16 is fully pressurized.

Referring now to FIG. 5, between 20 and 60 PSI, the piston 60 moves closer to the endcap 46, reducing the head pressure required for air to enter the storage tank 16 through the tank port 50. It will be seen that the piston 60 has moved away from the check valve poppet 52. During this stage, the user can still operate a tool or other device receiving air from the bypass port 48. Also, the light spring 58 is used to bias the check valve poppet 52 into seated position against the inlet port 54, but the biasing force generated by this spring is relatively easily overcome by incoming compressed air from the pump 12 so that air can enter the storage tank 16 through the tank port 50.

Referring now to FIG. 6, between 60 and 150 PSI, the piston 60 is seen fully seated against the endcap 46, and the heavy spring 64 is fully compressed. At this point, the tank pressure works against the piston 60 and the heavy spring 64, thus reducing the loading on the pump 12 for adding compressed air to the tank 16. Additional air need only overcome the light spring 58 to displace the poppet for entering the storage tank 16. This advantage reduces loading on the pump 12, and also reduces pump pressure load and temperature, thus prolonging pump life. In the preferred embodiment, the endcap 46 is provided with a vent 72 for venting the portion of the non-pressurized chamber 56 between the O-ring 62 and the endcap.

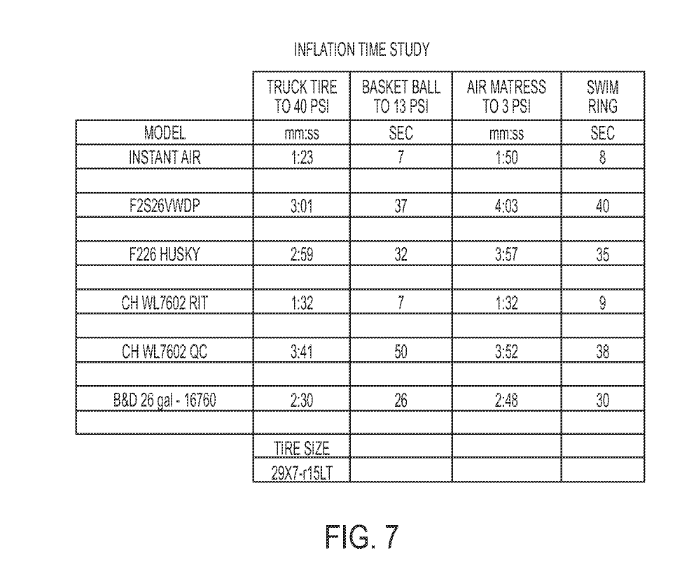

Referring now to FIG. 7, the chart compares the inflation time of a variety of compressor systems, the top-listed model being the present system 10 with the floating piston check valve 20. The time required to inflate a variety of consumer products is compared. It will be seen that the present system 10 makes compressed air available relatively earlier than most conventional systems, and using the present floating piston check valve, the pump is subjected to reduced loading, thus prolonging its operational life.

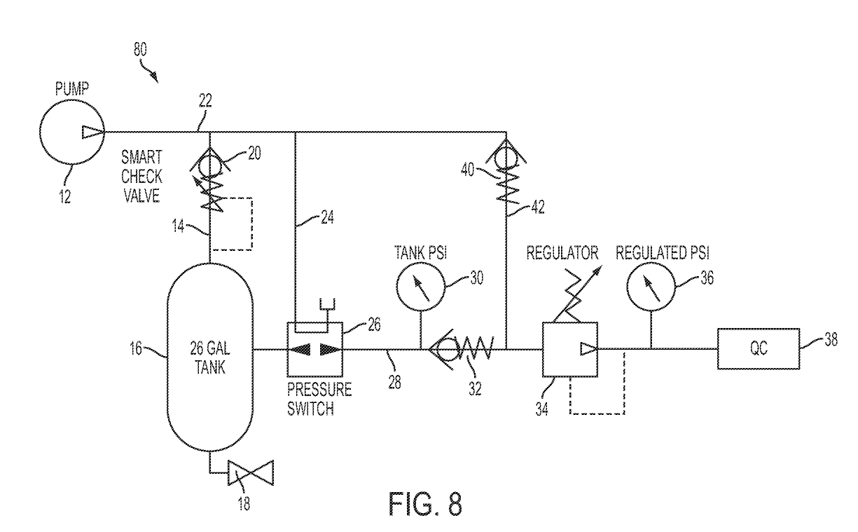

Referring now to FIG. 8, another embodiment of the compressor system of FIG. 1 is designated 80. Components shared with the system 10 are designated with identical reference numbers. A main difference between the system 10 and the system 80 is that the latter has the check valve 40 in the pump line 22 connected at the opposite end to the pressure switch line 28 between the pressure gauge 30 and the regulator 34. Thus, the check valve 40 is located “upstream” of the regulator 34. This adjustment has been found to improve operation by preventing bleeding off or gradual loss of line pressure to the quick connect fitting 38 by certain models of regulators 34 unless the regulator is set to maximum pressure. Also, as is the case with the system 10, in the system 80, the three check valves 20, 32 and 40 are remotely located from each other.

While particular embodiments of the present compressor system with rapid access valve has been shown and described, it will be appreciated by those skilled in the art that changes and modifications may be made thereto without departing from the invention in its broader aspects and as set forth in the following claims.

What is claimed:

1. A check valve for use in a compressor system including a pump and a storage tank, comprising:
a housing including an inlet connected to the pump, a tank port in fluid communication with the storage tank, and a bypass port, all in fluid communication with each other, and with a chamber;
a reciprocating piston disposed in said chamber and having a heavy spring at one end, and a light spring at the other end; and
said valve being constructed and arranged so that pressurized air is accessible from said bypass port prior to the storage tank being fully pressurized.

2. The check valve of claim 1 wherein said piston is provided with an O-ring seal to define a pressurized and a non-pressurized portion of the chamber.

3. The check valve of claim 2 wherein said non-pressurized portion is below said O-ring seal, and said pressurized portion is above said O-ring seal in said chamber.

4. The check valve of claim 1 further including a check valve poppet disposed at an upper end of said chamber between an upper end of said piston and an upper end of said chamber and being biased by said light spring against a chamber inlet port in fluid communication with said housing inlet.

5. The check valve of claim 1 wherein said heavy spring is constructed and arranged so that as the tank becomes pressurized, the tank pressure works against a biasing force of said heavy spring to reduce pump loading.

6. A compressor system, comprising:
a pump;
a storage tank in fluid communication with said pump;
a first check valve in fluid communication with and disposed between said pump and said storage tank;
a pressure switch in fluid communication with said storage tank and preset to shut off the pump when a preset tank pressure is reached;
a second check valve in fluid communication with and disposed between said pressure switch and a quick connect fitting;
said quick connect fitting being in fluid communication with said pump, separately from the connection with said pressure switch;
a third check valve in fluid communication with, and disposed between said pump and said quick connect fitting; and
one of said first, second and third check valves including a floating piston biased at one end by a heavy spring, and at an opposite end by a light spring.

7. The compressor system of claim 6 further including a poppet in said check valve with said floating piston is biased by said light spring against a chamber inlet port.

8. The compressor system of claim 6 wherein the three check valves are remotely located from each other.

9. The compressor system of claim 6 wherein said first check valve has a bypass port constructed and arranged so that pressurized air is accessible from said bypass port prior to the storage tank being fully pressurized.

10. The compressor system of claim 6 wherein all of said check valves are connected to said system upstream of a regulator in fluid communication with said bypass port.

11. The compressor system of claim 6 wherein said third check valve is located between said first check valve and said quick connect fitting.
